(19) United States
(12) Patent Application Publication
(10) Pub. No.: US 2013/0054189 A1
(43) Pub. Date: Feb. 28, 2013

(54) COMPUTING DEVICE, STORAGE MEDIUM AND METHOD FOR EXTRACTING DIMENSIONS OF PRODUCT USING THE COMPUTING DEVICE

(71) Applicants: CHIH-KUANG CHANG, Tu-Cheng (TW); XIN-YUAN WU, Shenzhen City (CN); JIN-GANG RAO, Shenzhen City (CN)

(72) Inventors: CHIH-KUANG CHANG, Tu-Cheng (TW); XIN-YUAN WU, Shenzhen City (CN); JIN-GANG RAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/517,547

(22) Filed: Jun. 13, 2012

(30) Foreign Application Priority Data
Aug. 30, 2011 (CN) 201110254280.5

(51) Int. Cl. G06F 15/00

(52) U.S. Cl. 702/155

(57) ABSTRACT

In a method for extracting dimensions of a product using a computing device, an engineering drawing of the product is read from a storage system of the computing device. A first layer of the engineering drawing that includes identifiers and a second layer of the engineering drawing that includes the dimensions are acquired. The identifiers in the first layer are extracted and added into a dimension list. The dimensions corresponding to each identifier in the second layer are extracted and added into the dimension list. Content of the dimension list is inserted into a report file. The report file is displayed on the display device.

### BACKGROUND

1. Technical Field

Embodiments of the present disclosure relate to data processing devices and methods, and more particularly to a computing device, a storage medium, and a method for extracting dimensions of a product using the computing device.

2. Description of Related Art

To assure high quality of a product, users need to acquire an engineering drawing (e.g. a computer aided design engineering drawing) of the product, manually extract dimensions of the product from the engineering drawing, and inspect the dimensions of the product. The dimensions may include identifiers, theoretical values, upper tolerances, and lower tolerances of measurement elements of the product, for example. However, since the measurement elements in the engineering drawing may be numerous, extracting the dimensions manually demands heavy use of manpower, which is expensive and prone to error.

### BRIEF DESCRIPTION OF THE DRAWINGS

FIG. 1 is a block diagram of one embodiment of a computing device including a dimensions extraction system.

FIG. 2 shows partial content of one example of an engineering drawing of a product.

FIG. 3 is a flowchart of one embodiment of a method for extracting dimensions of a product using the computing device of FIG. 1.

FIG. 4 shows one example of a dimension list of identifiers and dimensions of the product.

FIG. 5 shows some predetermined tolerances of theoretical values of the dimensions.

FIG. 6 shows locations of identifiers in the engineering drawing.

FIGS. 7A-7B show two user interfaces for displaying the dimension list.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable storage medium or other storage device. Some non-limiting examples of non-transitory computer-readable storage medium include CDs, DVDs, BLU-RAY, flash memory, and hard disk drives.

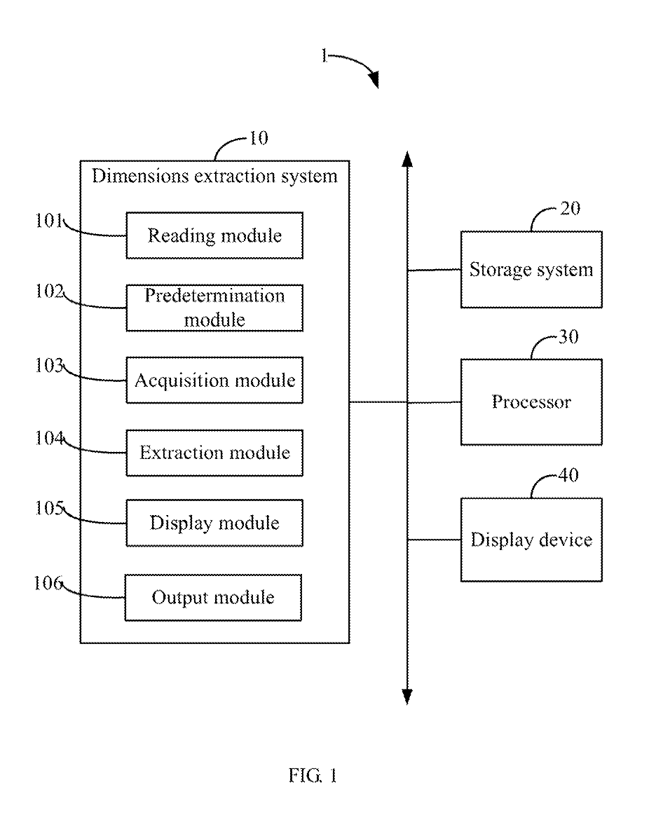

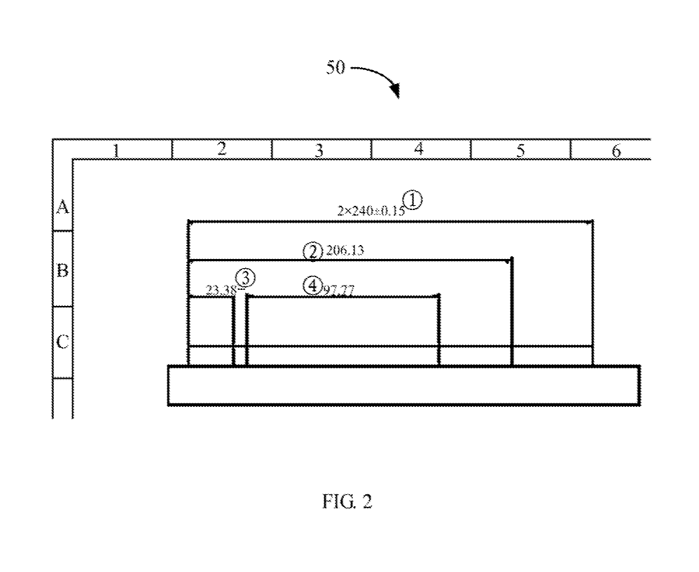

FIG. 1 is a block diagram of one embodiment of a computing device 1 including a dimensions extraction system 10. In the embodiment, the computing device 1 further includes a storage system 20, at least one processor 30, and a display device 40. The storage system 20 stores at least one engineering drawing 50 of a product, such as a computer aided design engineering drawing as shown in FIG. 2. The dimensions extraction system 10 may be in form of one or more programs that are stored in the storage system 20 and executed by the at least one processor 30. FIG. 1 is just one example of the computing device 1 that can be included with more or fewer components than shown in other embodiments, or have a different configuration of the various components. The engineering drawing 50 may include multiple layers where each layer may include different information about the product.

In one embodiment, the storage system 20 may be a random access memory (RAM) for temporary storage of information, and/or a read only memory (ROM) for permanent storage of information. In other embodiments, the storage system 20 may also be an external storage device, such as a hard disk, a storage card or a data storage medium. The at least one processor 30 executes computerized operations of the computing device 1 and other applications to provide functions of the computing device 1.

In one embodiment, the dimensions extraction system 10 may include a reading module 101, a predetermination module 102, an acquisition module 103, an extraction module 104, a display module 105, and an output module 106. The modules 101-106 may comprise a plurality of functional modules each comprising one or more programs or computerized codes that are stored in the storage system 20, and can be accessed and executed by the at least one processor 30.

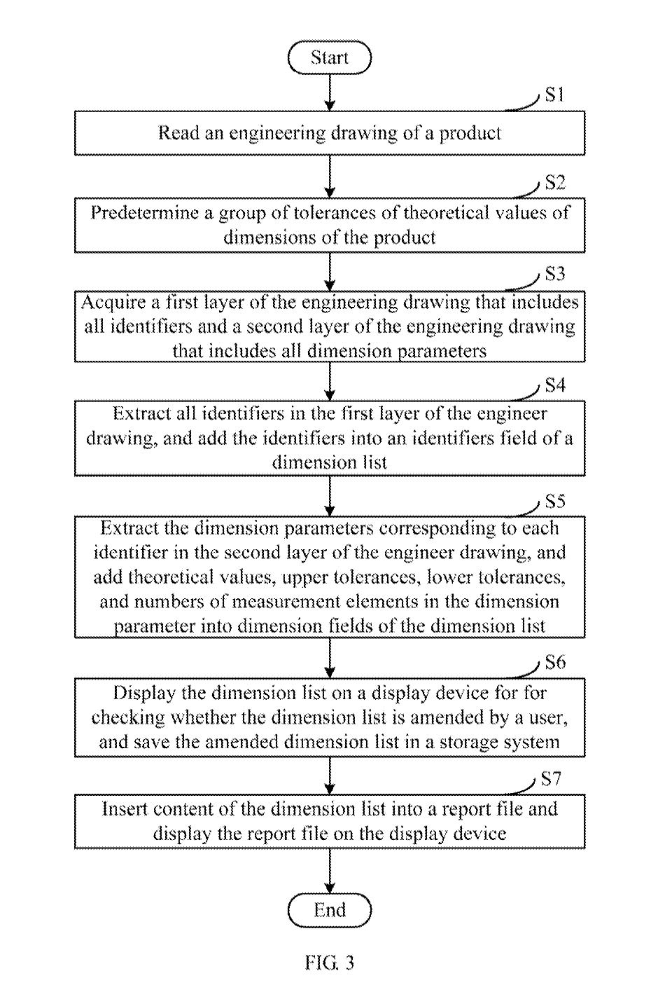

FIG. 3 is a flowchart of one embodiment of a method for extracting dimensions of a product using the computing device 1 of FIG. 1. Depending on the embodiment, additional steps may be added, others removed, and the ordering of the steps may be changed.

In step S1, the reading module 101 reads an engineering drawing 50 of the product from the storage system 20. The engineering drawing 50 may include a plurality of measurement elements, such as points, lines, or circles. The engineering drawing 50 further includes several unique identifiers and dimensions corresponding to the identifiers. Each of the identifiers corresponds to one or more measurement elements of the product. If one or more measurement elements have the same identifier, having the same identifier signifies that the one or more measurement elements have the same dimensions, such as the same shape, or width or length. In one embodiment, a dimension corresponding to the identifier indicates a theoretical value of the one or more measurement elements that have the identifier. In other embodiments, the dimension may further indicate an upper tolerance and a lower tolerance of the theoretical value, and a number of the one or more measurement elements which have that identifier.

Referring to FIG. 2, for example, a dimension “2×240±0.15” corresponding to an identifier “\textcircled{1}” indicates that the theoretical value is 240, that both the upper tolerance and the lower tolerance are 0.15, and that the number of measurement elements which have that identifier “\textcircled{1}” is two. For another example, a dimension 206.13 corresponding to an identifier “\textcircled{2}” indicates that the theoretical value is 206.13 and the number is one by default, but the dimension 206.13 does not indicate an upper tolerance or a lower tolerance.

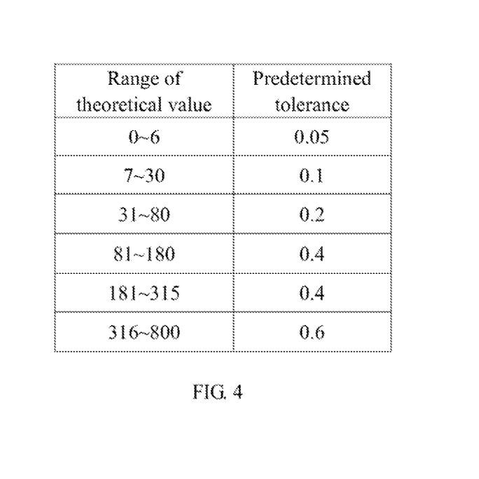

In step S2, the predetermination module 102 further predetermines a group of tolerances of theoretical values of the dimensions. If a dimension does not indicate an upper tolerance and a lower tolerance of a theoretical value of a dimension, the upper tolerance and the lower tolerance of the theoretical value can be determined according to the predetermined tolerances. For example, referring to FIG. 4, if a theoretical value is in a range from zero to six, an upper tolerance and a lower tolerance of the theoretical value are both determined as 0.05, and if a theoretical value is in a range from seven to thirty, an upper tolerance and a lower tolerance of the theoretical value are both determined as 0.1.

In step S3, the acquisition module 103 acquires a first layer of the engineering drawing 50 that includes all identifiers, and a second layer of the engineering drawing 50 that includes all dimensions. Usually, the engineering drawing 50 includes properties of each identifier and each dimension drawn in the engineering drawing 50. The properties may indicate a color, a line type, a line style, a layer, and a plot style of each identifier and each dimension, for example. The properties of an identifier or a dimension in the engineering drawing 50 indicate a layer where the identifier or the dimension is drawn. The acquisition module 103 can select an identifier and a dimension randomly, and acquire the first layer and the second layer of the engineering drawing 50 according to the properties of the identifier and the dimension in the engineering drawing 50.

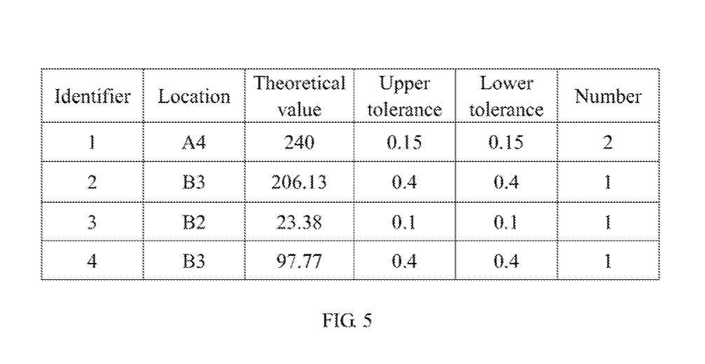

In step S4, the extraction module 104 extracts all identifiers in the first layer of the engineering drawing 50, and adds the identifiers into an identifier field of a dimension list 60 according to a sequence of the identifiers, as shown in FIG. 5. The dimension list 60 may include several fields for recording the identifiers and the dimensions, and the dimension list 60 is stored in the storage system 20.

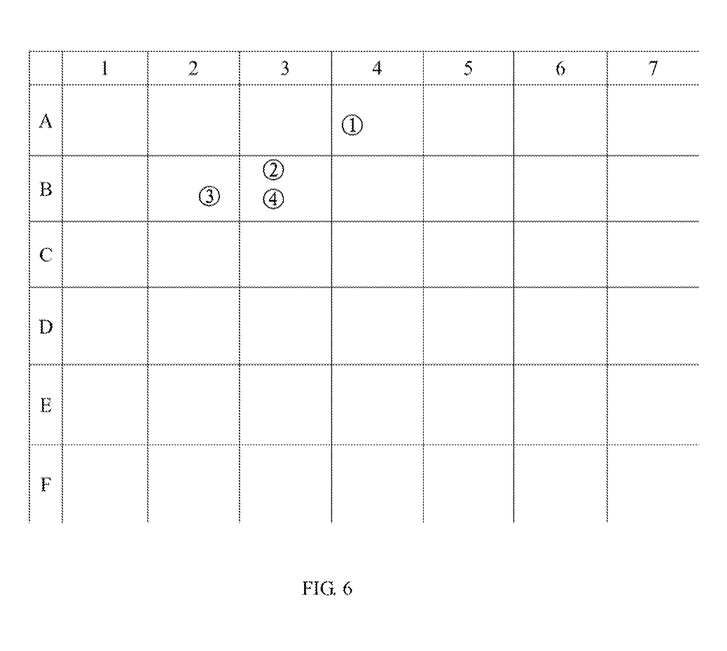

The extraction module 104 further extracts a location of each identifier in the engineering drawing 50, and adds the location of each identifier into a location field of the dimension list 60. For example, referring to FIG. 6, if the identifier “\textcircled{1}” is located in an “A” row and “4” column of the engineer drawing 50, the location of the identifier “\textcircled{1}” can be represented as “A4”.

In step S5, the extraction module 104 further extracts the dimensions corresponding to each identifier in the second layer of the engineer drawing 50, and adds the theoretical values, the upper tolerances, the lower tolerances, and the numbers of measurement elements indicated by each dimension into a dimension field of the dimension list 60, referring to FIG. 5. In the embodiment, if a location of an identifier is closest to a location of a dimension drawn in the engineering drawing 50, the extraction module 104 determines that the dimension corresponds to the identifier. For example, the identifier “\textcircled{1}” is closest to the dimension “2×240±0.15” in FIG. 2. If the dimensions do not indicate the upper tolerances and the lower tolerances, the extraction module 104 determines the upper tolerances and the lower tolerances according to the predetermined tolerances.

In step S6, the display module 105 displays the dimension list 60 on the display device 40 for allowing a user to check and amend the dimension list 60. The dimension list 60 includes the identifiers, the locations of the identifiers, the theoretical values, the upper tolerances, the lower tolerances, and the number of each type of measurement elements. If the user finds errors, such as duplicate identifiers in the dimension list 60, the user can amend the dimension list 60, and the display module 105 saves the amended dimension list 60 in the storage system 20.

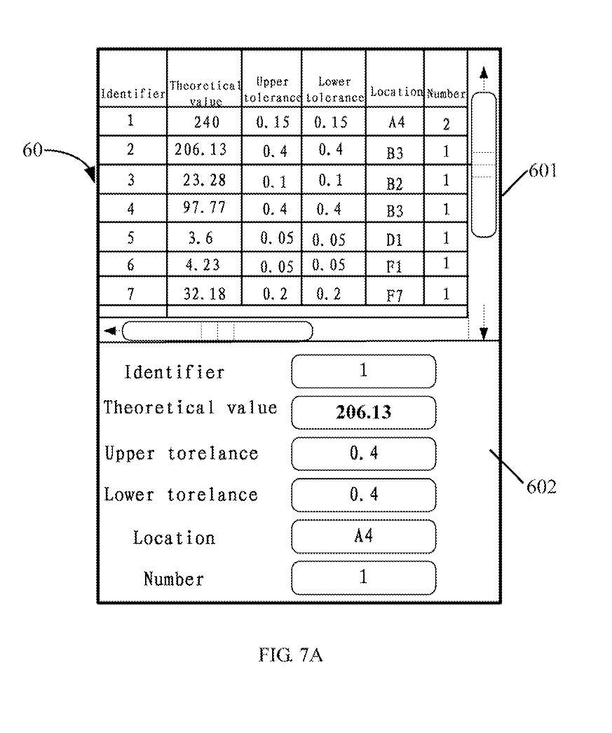

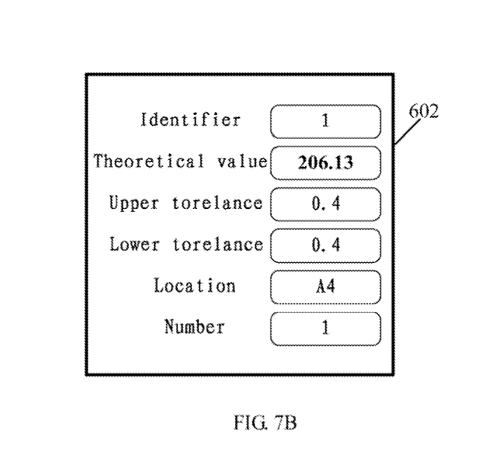

FIG. 7A shows a user interface for displaying the dimension list 60. The dimension list 60 includes a displaying area 601 and an amendment area 602. When the user selects a group of dimension data in the displaying area 601, such as the dimension data corresponding to the identifier “\textcircled{1}”, the user can amend the group of dimension data in the amendment area 602. The dimension list 60 can be simplified as the amendment area 602 displayed in FIG. 7B.

In step S7, the output module 106 inserts content of the dimension list 60 into a report file stored in the storage system 20 and displays the report file on the display device 60. The report file may be an EXCEL file, for example.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a storage system;
at least one processor;
one or more programs stored in the storage system and executed by the at least one processor, the one or more programs comprising:
a reading module that reads an engineering drawing of a product from the storage system, wherein the engineering drawing comprises several unique identifiers and dimensions of measurement elements corresponding to the identifiers;
an acquisition module that acquires a first layer of the engineering drawing that includes the identifiers, and a second layer of the engineering drawing that includes the dimensions;
an extraction module that extracts the identifiers in the first layer of the engineer drawing and adds the identifiers into a dimension list, extracts the dimensions corresponding to each identifier in the second layer of the engineer drawing, and adds a theoretical value, an upper tolerance, a lower tolerance, and a number of measurement elements indicated by each dimension into the dimension list;
a display module that displays the dimension list on a display device of the computing device, and saves amended dimension list in the storage system;
an output module that inserts content of the dimension list into a report file and displays the report file on the display device.

2. The computing device of claim 1, wherein the acquisition module acquires the first layer and the second layer according to properties of the identifiers and the dimensions in the engineering drawing.

3. The computing device of claim 1, wherein the extraction module further extracts a location of each identifier in the engineering drawing, and adds the location of each identifier into the dimension list.

4. The computing device of claim 1, wherein the extraction module further determines a dimension corresponds to an identifier if a location of the identifier is closest to a location of the dimension in the engineering drawing.

5. The computing device of claim 1, wherein the predetermination module further predetermines a group of tolerances of theoretical values of the dimensions.

6. The computing device of claim 5, wherein the extraction module determines the upper tolerances and the lower tolerances according to the predetermined tolerances if the dimensions do not indicate the upper tolerances and the lower tolerances.

7. A method for extracting dimensions of a product using a computing device, the method comprising:
(a) reading an engineering drawing of the product from a storage system of the computing device, wherein the engineering drawing comprises several unique identifiers and dimensions of measurement elements corresponding to the identifiers;
(b) acquiring a first layer of the engineering drawing that includes the identifiers, and a second layer of the engineering drawing that includes the dimensions;
(c) extracting the identifiers in the first layer of the engineer drawing and adding the identifiers into a dimension list;
(d) extracting the dimensions corresponding to each identifier in the second layer of the engineer drawing, and adding a theoretical value, an upper tolerance, a lower tolerance, and a number of measurement elements indicated by each dimension into the dimension list;
(e) displaying the dimension list on a display device of the computing device, and saving amended dimension list in the storage system;
(f) inserting content of the dimension list into a report file, and displaying the report file on the display device.

8. The method of claim 7, wherein the step (c) further comprises:
acquiring the first layer and the second layer according to properties of the identifiers and the dimensions in the engineering drawing.

9. The method of claim 7, further comprising:
extracting a location of each identifier in the engineering drawing, and adding the location of each identifier into the dimension list.

10. The method of claim 7, wherein the step (e) further comprises:
determining a dimension corresponds to an identifier if a location of the identifier is closest to a location of the dimension in the engineering drawing.

11. The method of claim 7, further comprising:
predetermining a group of tolerances of theoretical values of the dimensions.

12. The method of claim 11, wherein the step (e) further comprises:
determining the upper tolerances and the lower tolerances according to the predetermined tolerances if the dimensions do not indicate the upper tolerances and the lower tolerances.

13. A non-transitory storage medium storing a set of instructions, the set of instructions capable of being executed by a processor of a computing device, causes the computing device to execute a method for extracting dimensions of a product, the method comprising:
(a) reading an engineering drawing of the product from a storage system of the computing device, wherein the engineering drawing comprises several unique identifiers and dimensions of measurement elements corresponding to the identifiers;
(b) acquiring a first layer of the engineering drawing that includes the identifiers, and a second layer of the engineering drawing that includes the dimensions;
(c) extracting the identifiers in the first layer of the engineer drawing and adding the identifiers into a dimension list;
(d) extracting the dimensions corresponding to each identifier in the second layer of the engineer drawing, and adding a theoretical value, an upper tolerance, a lower tolerance, and a number of measurement elements indicated by each dimension into the dimension list;
(e) displaying the dimension list on a display device of the computing device, and saving amended dimension list in the storage system;
(f) inserting content of the dimension list into a report file, and displaying the report file on the display device.

14. The storage medium of claim 13, wherein the step (c) further comprises:
acquiring the first layer and the second layer according to properties of the identifiers and the dimensions in the engineering drawing.

15. The storage medium of claim 13, wherein the method further comprises:
extracting a location of each identifier in the engineering drawing, and adding the location of each identifier into the dimension list.

16. The storage medium of claim 13, wherein the step (e) further comprises:
determining a dimension corresponds to an identifier if a location of the identifier is closest to a location of the dimension in the engineering drawing.

17. The storage medium of claim 13, wherein the method further comprises:
predetermining a group of tolerances of theoretical values of the dimensions.

18. The storage medium of claim 17, wherein the step (e) further comprises:
determining the upper tolerances and the lower tolerances according to the predetermined tolerances if the dimensions do not indicate the upper tolerances and the lower tolerances.
